(19) United States
(12) Patent Application Publication
(10) Pub. No.: US 2003/0192060 A1
(43) Pub. Date: Oct. 9, 2003

(54) Digital watermarking and television services

(76) Inventor: Kenneth L. Levy, Stevenson, WA (US)

Correspondence Address: DIGIMARC CORPORATION, 19801 SW 72ND AVENUE, SUITE 100, TUALATIN, OR, 97062, US

(21) Appl. No.: 10/366,629

(22) Filed: Feb. 12, 2003

Related U.S. Application Data
(63) Continuation-in-part of application No. 10/060,049, filed on Jan. 28, 2002.
(60) Provisional application No. 60/356,878, filed on Feb. 12, 2002.
(60) Provisional application No. 60/265,392, filed on Jan. 30, 2001.
(60) Provisional application No. 60/270,782, filed on Feb. 20, 2001.
(60) Provisional application No. 60/276,543, filed on Mar. 15, 2001.

(51) Int. Cl. H04N 7/173; H04N 7/16

(52) U.S. Cl. 725/133; 725/153; 725/141; 725/110; 725/112

(57) ABSTRACT

A digital watermark is embedded in video content, like an advertisement. A digital video recorder (“DVR”) includes a digital watermark decoder to decode the digital watermark. Once decoded, an identifier is communicated to an interactive television service provider. The identifier is used to identify information related to the watermarked content (like a message, email, video email, further advertising, etc.). Once identified, the related information is forwarded to the DVR. In a related embodiment, the related information is pushed to the DVR in advance of a request. The related information is activated once a user selects corresponding content. In addition, the digital watermark can be used to control recording, fast-forwarding, skipping, pausing, and/or saving timing limits. Additionally, dynamic skip button usage is enabled for improved consumer experience.

### RELATED APPLICATION DATA

This application claims the benefit of U.S. Provisional Patent Application No. 60/356,878, filed Feb. 12, 2002. This application is also a continuation-in-part of U.S. patent application Ser. No. 10/060,049, filed Jan. 28, 2002, which claims the benefit of U.S. Provisional Patent Application No. 60/265,392, filed Jan. 30, 2001, 60/270,782, filed Feb. 20, 2001, and 60/276,543, filed Mar. 15, 2001. Each of these U.S. Patent documents is herein incorporated by reference.

The subject matter of the present application is also related to that disclosed in assignee's U.S. patent application Ser. No. 09/597,209, filed Jun. 20, 2000, Ser. No. 09/660,756, filed Sep. 13, 2000, and Ser. No. 10/002,225, filed Nov. 20, 2001, and U.S. Pat. No. 6,122,403. Each of these patent documents is herein incorporated by reference.

### FIELD OF THE INVENTION

The present invention relates to digital watermarking, and is particularly illustrated in the context of interactive television services and video recorders.

### BACKGROUND AND SUMMARY OF THE INVENTION

Personal and digital video recording devices (PVRs and DVRs, hereafter used interchangeably) are improving. Consumers, no longer shackled by VHS recorders, are experiencing unbridled flexibility in their television viewing. Generally, DVRs include a hard drive or other storage device to record multimedia programming (e.g., TV shows, televised sporting events, movies, advertisements, etc). We sometimes use the term “content” interchangeably with programming. DVRs provided enhanced recording options, including simultaneous recording of multiple programs.

Television services have emerged to support these technological advancements. Consider TiVo® for example. A customer purchases a TiVo® recorder and signs up for the TiVo® service. The TiVo® service/recorder cooperate with virtually any TV system: antenna, cable, digital cable, satellite and combinations of such. The TiVo® recorder provides enhanced digital recording for the user. (Consider a user watching a football game. After a great touchdown run, the user can replay and re-watch the run, while her TiVo® recorder continues to record the game.).

The TiVo® recorder also provides a user interface, viewable via the television. In some ways its the beginning of convergence between a TV and personal computer. The user interface allows the user to peruse a programming guide, make recording TM selections and select programming options. For example, TiVo's Season Pass™ feature automatically records every episode of a series, all season long, even if the date and timeslot change. Or TiVo's WishList™ feature finds and automatically records shows that feature a favorite actor, team, topic, hobby, etc. Still further, TiVo® offers a message service. Messages are forwarded to a user's TiVo® recorder, and are viewable/selectable via an electronic program guide or message center interface. The TiVo® recorder (like other DVRs) includes a return (or “back”) channel. A back channel is typically used to update the programming guide and to send or push messages to a TiVo recorder.

While various television services for DVRs have been described with reference to TiVo, the present invention is not limited to such. Indeed, my inventive techniques are applicable to many other television service providers and recorders including SonicBlue's Replay® and UltimateTV® by Microsoft, DishPVR®, among many others. While the DVRs described above will typically reside in a consumer's home or office, a video storage device can also be located at a service provider location, such as a cable operator's head-end. The shows are recorded at the head-end and the user can view the recorded programming via a video on demand (VOD) service or other content network.

I have developed a system and method to enhance television services. In one embodiment, a digital watermark (described below) is embedded in video content, like an advertisement. The digital watermark may include an identifier. The digital watermark can be redundantly embedded per video frame or video sequence, or can be embedded in discrete frames or predetermined video sequences. Similarly, embedding of a digital watermark can be limited to objects within a frame or sequence (e.g., a soda can, car, etc.). A DVR includes a digital watermark decoder to decode the digital watermark identifier. Once decoded, the identifier is communicated to an interactive television service provider. The identifier is used to identify information related to the watermarked content (like a message, interactive content, further advertising, etc.). Once identified, the related information is forwarded to the DVR. In a related embodiment, the related information is pushed to the DVR in advance of a request. The related information is activated once selected by a user, e.g., when a user selects a corresponding digitally watermarked video frame or watermarked object within a frame. In addition, a digital watermark can contain both an identifier and timestamp. Then depending on what time the consumer selects (or views) the advertisement, the type of interactive content sent to a consumer may change. Similarly, the digital watermark may contain other information, such as to whether a host show or advertisement can or cannot be recorded, for how long a show or advertisement can be saved, can commercials be skipped, etc.

Digital watermarking is a process for modifying physical or electronic media to embed a machine-readable code into the media. The media may be modified such that the embedded code is imperceptible or nearly imperceptible to the user, yet may be detected through an automated detection process. Most commonly, digital watermarking is applied to media signals such as images, audio signals, and video signals. However, it may also be applied to other types of media objects, including documents (e.g., through line, word or character shifting), software, multi-dimensional graphics models, and surface textures of objects.

Digital watermarking systems typically have two primary components: an encoder that embeds the watermark in a host media signal, and a decoder that detects and reads the embedded watermark from a signal suspected of containing a watermark (a suspect signal). The encoder embeds a watermark by altering the host media signal. The reading component analyzes a suspect signal to detect whether a watermark is present. In applications where the watermark encodes information, the reader extracts this information from the detected watermark.

Several particular watermarking techniques have been developed. The reader is presumed to be familiar with the literature in this field. Particular techniques for embedding and detecting imperceptible watermarks in media signals are detailed in the assignee's co-pending U.S. patent application Ser. No. 09/503,881 and U.S. Pat. No. 6,122,403, which are each herein incorporated by reference. Of course, the present invention is not limited to assignee's digital watermarking techniques.

The foregoing and other features and advantages of the present invention will be even more apparent from the following detailed description, which proceeds with reference to the accompanying drawings.

### BRIEF DESCRIPTION OF THE DRAWINGS

FIG. 1 illustrates a digital video recorder (DVR) according to one aspect of the present invention.

FIG. 2 is a flow diagram illustrating one aspect of my invention.

### DETAILED DESCRIPTION

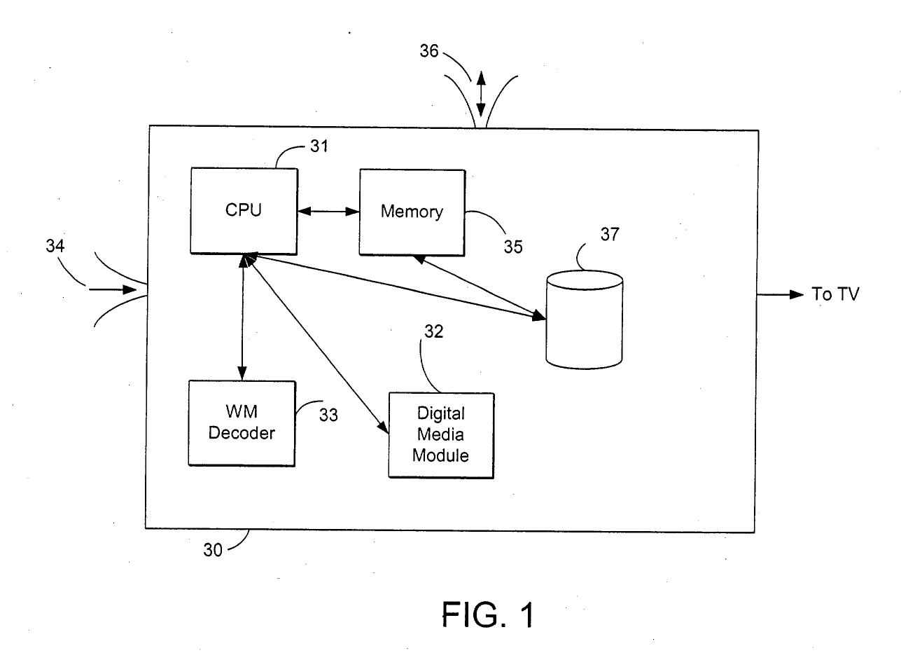

FIG. 1 is a block diagram illustrating various DVR 30 components. DVR 30 includes an input 34 through which content is received. The term content and programming are used broadly herein and include, e.g., TV programs, electronic program guides, advertisements, messages, games, movies, audio, video, text, etc. Input 34 may communicate with a set-top box, decoder or with a television system—regardless of whether it is cable, digital cable, satellite, antenna, etc. Electronic processing circuitry 31 (e.g., a CPU, electronic circuitry, etc.) is provided to help facilitate signal processing. Digital media module 32 is optionally provided to help process digital signals, e.g., MPEG-1 or MPEG-2 signals. The DVR 30 includes a storage device 37 for recording content. Storage device 37 preferably includes a hard drive (e.g., magnetic memory). However, in alternative implementations, storage device 37 includes electronic memory circuits, optical memory, removable memory, etc. DVR 30 also includes memory 35 such as RAM and/or ROM. Of course DVR 30 includes various bus structure (not shown) to facilitate signal communications between the various DVR components. (DVRs, such as TiVo, which receives analog content typically digitizes the analog content prior to storage on the storage device 37. Suitable analog-to-digital converters are known in the art and may be included in a DVR. Other DVRs, such as DishPVR, which receive digital content, save the received digital content to storage device 37 without such a conversion.). DVR 30 includes a digital watermark decoder 33. The watermark decoder 33 detects and decodes digital watermarks, which may be embedded in content. Of course, digital watermark decoder 33 may be realized with software and/or hardware. A software decoder implementation (e.g., software instructions) preferably runs on the CPU 31, but can also run on the digital media module 32. In another implementation, a hardware decoder communicates with the CPU 31, media module 32, or both.

DVR 30 includes software instructions stored in storage device 37 and/or memory 35. The software instructions provide a user interface and/or controller to control DVR 30 device operations such as recording, forwarding, pausing, skipping, program guide selections, etc. (In some implementations, instead of software, at least some of the relevant instructions are hardwired.). The software instructions may even include watermark decoder 33.

A back channel 36 is used to communicate with an interactive television service (e.g., TiVo®, UltimateTV®, etc., etc.). The back channel 36 can operate over a phone line, broadband cable, satellite feed, etc. The interactive television service provides features such as an electronic programming guide, messages, interactive content, programming updates, and “related information,” etc. We sometimes use these terms interchangeably in this application. The interactive television service may provide the related information to the DVR 30 via the DVR's input 34; but in a more preferred implementation, the related information is communicated to the DVR 30 via back channel 36. The entity, process and/or network which routes related information to a DVR can be referred to as a “response network,” “interactive television service” and/or “interactive content provider.” We sometimes use these terms interchangeably.

Interactive Ad

An “interactive ad” is an advertisement that when selected by a consumer provides the consumer with related information. The related information may include a text email, interactive content, a web page, a Macromedia flash animation, a video clip (e.g., additional advertisements, video email), etc. The related information is preferably sent to the DVR 30, e.g., when the DVR 30 updates its electronic programming guide (“EPG”). A DVR typically updates it EPG on a periodic basis (e.g., daily) and often updates in the early morning hours. As discussed below, the related information can alternatively be acquired nearly instantly or can be previously pushed to the DVR in advance of upcoming advertisement airtimes. In addition, without a broadband back channel, this “bookmark” type delivery may be preferred to send large files with additional information. In an alternative implementation, my inventive system is configured to send the related information to an Internet email account instead of or in addition to the DVR. The Internet email account may be preferable since it may have a broadband Internet connection, as well as enabling instantaneous interaction with the related information (e.g., via URL links, email, online shopping, etc.).

DVR-Based Interactive Advertising System

A DVR-based interactive advertising system is now described. A digital watermark is embedded in an advertisement. The digital watermark includes an identifier to uniquely identify the advertisement. An advertisement may even be subdivided into sets, and a unique identifier associated with each subset. For example, particular commercial segments and/or video frames may each include unique identifiers. The watermark identifier optionally includes a time code, which can be used to identify a particular advertisement section or lapsed seconds since the start of the advertisement.

(We note that the digital watermark preferably survives broadcast to a DVR, e.g., without debilitating alteration and/or cooperation from a network, cable or satellite service provider. A digital watermark identifier is also desirably included in the advertisement since advertisements are not typically listed in an electronic programming guide (“EPG”).).

In a first implementation, a digitally watermarked advertisement includes a graphic or other visible icon. The graphic/icon evidences that the advertisement includes embedded data or that the advertisement can be selected to retrieve additional or related information. An audible indicator optionally accompanies the graphic/icon. The indicator helps a viewer know that she can select or click on the advertisement. In a second implementation, digital watermark decoder 33 operates in the background perhaps continuously for incoming content—searching for digital watermarks. Once found, decoder 33 prompts the DVR 30 to display a graphic or icon to indicate a digital watermark or the possibility of obtaining related information.

Regardless of the graphic display implementation, once a graphic appears in the user's television screen, the user optionally clicks, selects or otherwise bookmarks (e.g., saves and indexes) the advertisement. We note that most DVRs include remote controls, which can include a button or menu to facilitate such advertisement selection. A DVR remote control usually includes advanced buttons for navigating the EPG, including a “select” button, which can be used to select an ad for bookmarking. Once bookmarked, the advertisement is archived and listed in the user's electronic programming guide (or other user interface folder or interface).

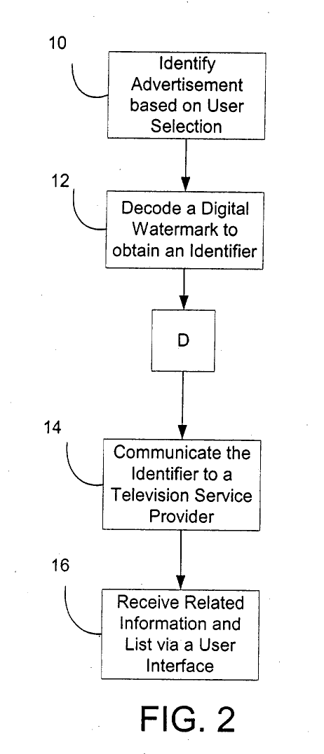

As shown in FIG. 2, when prompted by the user selection (step 10), the decoder 33 preferably detects and decodes the digital watermark identifier embedded within an advertisement (step 12). The DVR 30 saves the watermark identifier for uploading to the user's interactive television service. The watermark identifier can be forwarded, along with the user's account identifier, at the onset of the periodic (e.g., daily as discussed above) electronic programming guide (EPG) update (step 14). We note that under most electronic guide updating schemes, there will be a delay (D) between selecting an advertisement and communicating a decoded watermark to the television service provider. The watermark ID is used to identify the advertisement or related information via a central database interrogation. The related information can include a message, additional advertisements, purchase information, product specifications, manufacture information, testimonials, etc., etc. Once identified, and typically while the EPG is updated, the related information is communicated via the back channel 36 to the DVR 30. The related information (e.g., a message) can be listed in the user's interface, e.g., in a message box or even the program guide, etc., as in step 16.

In a second implementation, decoder 33 automatically looks for and decodes digital watermarks from content input and/or recorded on a DVR. Decoded watermark identifiers are saved and communicated to the television service provider as in step 14 discussed above. Then, instead of listing the related information in the user interfaces message box (or other folder), the related information, such as an interactive message, is hidden or otherwise listed as unviewed or unsolicited. The related information is activated or otherwise listed for viewing if the user selects a recorded advertisement. (We note that the related information can alternatively be listed in the electronic programming guide instead of being hidden, depending on user preference.). This activation may occur hours or even days after the content was received or recorded.

As an alternative implementation, related information is pushed or sent to DVR 30 without solicitation. (The interactive television service provider can coordinate related information transmission with upcoming advertisements.). The related information is sent to the DVR 30 over its back channel 36, possibly over several nights, before the scheduled broadcast of the ad, or can be seen via the broadcast input 34. When using the broadcast input 34, the related information can be embedded within or included in an existing dedicated channel (e.g., a data carousel channel) or contained in a separate or special channel. (For example, television channel 62 may be designated as a data channel—the carousel channel.). Since the related information is stored locally, a user is afforded immediate interactivity once the ad is broadcast and selected, without needing a broadband or an “always-on” back channel connection. The digital watermark identifier can be used as a local database index to help manage the stored related information. These unsolicited messages can be hidden or otherwise labeled as unsolicited. The messages are then activated once a user selects a corresponding advertisement, e.g., when viewing previously recorded programming. This alternative improves the message response time once a user selects an advertisement.

In still another implementation, instead of waiting for the periodic update to communicate a digital watermark identifier, a user selects—or the DVR is automatically programmed to activate—a “get now” option. The “get now” option establishes a communications link with the interactive television service to obtain the related information. The get now option provides a more interactive viewing experience. (We note that this implementation avoids the delay (D) shown in FIG. 2.).

Of course, we anticipate that futuristic DVRs will provide or cooperate with other devices to provide web browsing or internet access. My inventive watermark identifying features can be used with such DVRs to identify interactive content and to efficiently link to related information.

Digital watermarks can also include date-time stamps to facilitate audience advertisement measurements. For example, decoder 33 decodes digital watermarks embedded in advertisements. Recovering the time stamp indicates how much of an advertisement is actually viewed (and not just recorded). The DVR can even determine if the ad was viewed in regular speed or one of several fast forward modes.

Instead of marking the advertisement with a visual or audible logo to let the consumer know that the advertisement is interactive, the DVR service provider can let the consumer know that certain advertisements are interactive, e.g., through promotional ads, messages or other communications avenues to motivate the consumer to interact with the advertisement. For example, a DVR service provider (e.g., TiVo) may facilitate a raffle for a Lexus that involves using a DVR to watch a number (e.g., 4) of Lexus ads and requesting related information to receive clues to win the car. The user may even need to watch the ads or related information in slow motion to pick-up clues from the ads/related information. A digital watermark identifier can be used to verify that the user watched the ad (e.g. via the watermark time-stamp) or to request the related information for the ad or raffle (e.g., via the watermark identifier).

Digitally watermarked ads may even help promote remote triggering models, e.g., with Wink, OpenTV and other interactive TV companies In order for interactive TV to work, many TV shows and ads need to be activated. This helps pay for the infrastructure, as well as train the consumer to interact with the TV. With DVRs, a digital watermark is preferred since a DVR service provider may not always have a relationship with the broadcaster and TV service provider. As such, watermark detectors can be placed in a distribution head-end, which then embed specific triggers, such as VBI triggers in the content, for the STB or DVR to read and interact with.

Watermarks in Digital Video Recorders

One object of this aspect of the present invention is to prevent or limit people from fast-forwarding through advertisements when viewing recorded programs. To facilitate this objective, we embed a digital watermark within an advertisement. The watermark can include an identifier or code. The identifier or code can be used to regulate fast forwarding. For example, a watermark detector within a DVR detects the embedded watermark within the advertisement. The identifier is recovered. The identifier is communicated to a controller (e.g., DVR controller) to regulate (e.g., disable or restrict) fast-forwarding of the respective advertisement. In a variation of this implementation, a digital watermark is embedded in the program just prior to the advertisement. The watermark can be used to disable or regulate fast-forwarding for a predetermined length of time (e.g., until the advertisement has played) or until a second watermark is detected. The second watermark may include a message to enable fast-forwarding again.

In another implementation, a controller regulates the ability to fast-forward through a commercial or advertisement based on an amount of program viewed in regular time. For example, if someone fast-forwards through a program, they may be able to fast-forward through commercials. The controller preferably regulates the ability to fast forward through commercials by detecting digital watermarks. For example, an advertisement may include a digital watermark therein, which is used to prevent fast forwarding of the advertisement; or, if a watermark is detected, and the controller determines that the program has been fast forwarded up until the advertisement, then the advertisement can be fast-forwarded through. Another alternative, a program may include a digital watermark in content just prior to the placement of an advertisement. The detection of such a watermark may prevent fast-forwarding unless, for example, the DVR determines that the program has been fast forwarded through prior to the advertisement.

The amount of time that program content is viewed can be determined from a clock or counter started at the start and stop of fast forwarding, e.g., taking into account the fast forward rate. For example, if fast-forwarding at 2X real-time, the clock or counter preferably accounts for the 2X recording speed. The amount of time of required advertising viewing can be determined from the clock or counter. Alternatively, a watermark can carry time codes which can be used to determine a viewing time.

In another implementation, if someone wants to skip two minutes of commercials, they need to skip two minutes of program (or a proportional amount, e.g., 1 minute of commercial for 3 minutes of show, etc.) prior to the commercials, which usually includes important or suspenseful parts of a TV program. On the other hand, this means if someone wants to watch the last half of a TV show (or movie), possibly where he/she previously watched the other half before, he/she can fast forward through the commercials in the first half of the movie (i.e. doesn't have to watch the commercials in the first half of the movie) which he/she is not watching. A watermark identifier can be stored or indexed to evidence that such an advertisement has been previously viewed.

In addition, a digital watermark identifier can communicate different control scenarios to a controller. For example, based on a predetermined identifier, the controller may not allow fast forwarding in any circumstance, or may only allow fast forwarding for a portion of an advertisement. Instead of an identifier, similar functionality can be communicated to a controller by an absence of a watermark in an advertisement, a separate watermark, etc.

A watermark can be embedded in a commercial prior to broadcast, e.g., during creation, and a watermark detector can be located in a DVR device. (If shows are watermarked, they are typically embedded prior to broadcasting. In a video on demand (“VOD”) with PVR services, a watermark detector could be located on a VOD server.).

In a further implementation we use a hash of a video frame (or sequence of frame, or even a hash of an object in a frame) as an identifier. The hash identifier is used to help control fast forwarding, time coding, etc.

Copying, Pause, etc.

A digital watermark identifier may contain information about whether a TV program can be recorded, or how long the program can be paused or saved on storage device 37. The watermark decoder 33 can interpret the identifier to decide copy control or pause/save limits, and send the results to the CPU 31 or controller to ensure the DVR is controlled accordingly. A digital watermark may include a “save until” code or field to indicate how long a TV program should be saved on storage device 37. TV programs can be deleted from storage device 37 once the “save until” date arrives. The TV program can be indexed in a DVR file system to be deleted on or after a certain date.

Skip Button

A DVR may not only fast forward, but may also include a so-called “skip” button or functionality. A skip button skips a predetermined amount of program or advertisement material (or fast forwards for a predetermined amount of time). A watermark can be used to enable or disable a skip function. For example, if a digital watermark indicates a skip, the skip button can skip, e.g., around 29 seconds or slightly less than 30 seconds, as it takes about 1 second for a user to see if the program is a TV show or advertisement after pressing skip. Having a 29 second skip (or other predetermined time) means that the user will not need to hit a rewind button a few times after skipping commercials. The system could even have the skip as 30 seconds (labeled repeat skip length) if pressed within 0.5 seconds (labeled repeat delay) of a previous skip (e.g., skip is selected repeatedly). Of course, a digital watermark can be used to disable a skip function as well.

Alternatively, if advertisements stop being a standard 30 seconds, the skip button can be slightly less than a new standard advertisement length. In addition, the user may be able to set up the initial skip length, repeat delay, and repeat skip length in a user setup interface of a DVR.

Even without a watermark detector, this dynamic skip functionality could be of great benefit to a user.

### Conclusion

To provide a comprehensive disclosure without unduly lengthening this specification, the patents and applications cited above are incorporated herein by references, together with U.S. patent application Ser. No. 09/571,422, filed May 15, 2000.

Having described and illustrated the principles of the invention with reference to illustrative embodiments, it should be recognized that the invention is not so limited.

For example, while the specification referred to a few examples of digital watermarking technology, the field is broad and growing. Any watermarking technology capable of communicating a sufficient payload (e.g., for a content identifier or control messages) can be employed. In addition, out-of-band technology can be used in conjunction with a digital watermark to carry an identifier.

The implementation of the functionality described above (including watermark decoding) is straightforward to artisans in the field, and thus not further belabored here. Conventionally, such technology is implemented by suitable software, stored in long-term memory (e.g., disk, ROM, etc.), and transferred to temporary memory (e.g., RAM) for execution on an associated CPU. In other implementations, the functionality can be achieved by dedicated hardware, or by a combination of hardware and software. Reprogrammable logic, including FPGAs, can advantageously be employed in certain implementations.

It should be recognized that the particular combinations of elements and features in the above-detailed embodiments are exemplary only; the interchanging and substitution of these teachings with other teachings in this and the incorporated-by-reference patents/applications are also contemplated.

Of course, it will be recognized that the term “communicate” is not necessarily limited to direct communication. Instead, such communication may be facilitated via a router(s), buffers, amplifiers, network, cache, etc.

It should be appreciated that while the above description has proceeded with reference to digitally watermarked advertisements, the present invention is not so limited. Indeed other content, including programming, news, etc. can be similarly watermarked to provide related functionality. Moreover, it should be understood that the FIG. 1 DVR is but one of many implementations. Other suitable DVRs may include additional components as well.

The above section headings are not intended to provide substantive limitations for the present invention; but are instead provided for the reader's convenience. It will be appreciated that the features and elements discussed under a first section heading may be combined or interchanged with features discussed in a second section heading.

In view of the wide variety of embodiments to which the principles and features discussed above can be applied, it should be apparent that the detailed embodiments are illustrative only and should not be taken as limiting the scope of the invention. Rather, I claim as my invention all such modifications as may come within the scope and spirit of the following claims and equivalents thereof.

What is claimed is:

1. A method of operating a digital video recorder, the digital video recorder having an input to receive content, said method comprising the steps of:
decoding a digital watermark embedded in content, the digital watermark comprising an identifier;
communicating the identifier to an interactive television service provider; and
receiving related information in response to communicating the identifier.

2. The method of claim 1, further comprising delaying said communicating step until a predetermined time.

3. The method of claim 2, wherein the predetermined time comprises an electronic programming guide updating session.

4. The method of claim 2, wherein the related information comprises at least one of a text email, video email, advertisement, product information, promotional, web page, flash animation, and a video clip.

5. The method of claim 2, wherein the digital video recorder comprises a back channel input and the related information is received through the back channel input.

6. The method of claim 2, wherein the related information is received in an internet email account.

7. The method of claim 1, wherein the digital video recorder comprises an electronic programming guide and said method further comprises listing the related information in the electronic programming guide only after the content is selected by a user of the digital video recorder.

8. The method of claim 1, wherein said decoding step is carried out only when the content is selected by a user of the digital video recorder.

9. The method according to claim 1, wherein the content comprises at least one of an advertisement, television program and news program.

10. A method of operating a digital video recorder, the digital video recorder having an input to receive content and a back channel to receive related information, the digital video recorder further comprising a storage device and digital watermark decoder, said method comprising the steps of:
receiving related information from an interactive network, the related information corresponding to a content item;
storing the related information in the storage device;
receiving the content item after receiving the related information;
upon a user selection, decoding a digital watermark embedded in the content item with the digital watermark decoder, the digital watermark comprising an identifier;
providing the identifier to obtain the related information stored in the storage device; and
rendering the related information for selection or viewing.

11. A method of operating a digital video recorder, the digital video recorder having an input to receive content and a back channel to receive related information, the digital video recorder further comprising a storage device and a digital watermark decoder, said method comprising the steps of:
receiving content comprising an advertisement, the advertisement including a digital watermark embedded therein, the digital watermark including a timestamp;
decoding the watermark with the digital watermark decoder to obtain the timestamp; and
providing the timestamp to a television service provider.

12. A method of providing an incentive for viewing content stored on a digital video recorder, the digital video recorder having at least an input to receive content, the digital video recorder further comprising a storage device and a digital watermark detector, said method comprising the steps of:
decoding a digital watermark embedded in content, the digital watermark comprising an identifier;
communicating the identifier to a television service provider; and
receiving related information in response to communicating the identifier.

13. The method of claim 12, wherein the related information comprises incentive information.

14. The method of claim 13, wherein the incentive information comprises a contest.

15. A method to limit advertisement skipping, the advertisement being provided to a digital video recorder with associated content, the digital video recorder comprising a digital watermark decoder, the content comprising a digital watermark placed in the content at least prior to the advertisement, said method comprising the steps of:
decoding the digital watermark with the digital watermark decoder; and
based at least in part on the decoded digital watermark inhibiting the digital video recorder from at least one of skipping and fast-forwarding through the advertisement.

16. The method of claim 15, wherein the digital video recorder is not inhibited when a predetermined amount of content prior to said advertisement is fast-forwarded or skipped.

17. A method to enable skipping of a section of content, the content being provided to a digital video recorder, the digital video recorder comprising a digital watermark decoder, the content comprising a digital watermark, said method comprising the steps of:
decoding the digital watermark with the digital watermark decoder; and
based at least in part on the decoded digital watermark, enabling at least one of a skip function and fast-forward through the content.

18. The method of claim 17, wherein the content comprises at least one advertisement.

19. The method of claim 18, wherein the enabled skip function skips a predetermined amount of the content.

20. The method of claim 19, wherein the predetermined amount is less than the length of the at least one advertisement.
